(19) United States
(12) Patent Application Publication
(10) Pub. No.: US 2025/0139109 A1
(43) Pub. Date: May 1, 2025

(54) TIME-SERIES DATABASE FOR FAST PRIMARY KEY LOOKUPS

(71) Applicant: ServiceNow, Inc., Santa Clara, CA (US)

(72) Inventor: Timothy Smith, Sudbury, MA (US)

(21) Appl. No.: 18/385,799

(22) Filed: Oct. 31, 2023

(51) Int. Cl. G06F 16/2458; G06F 16/22; G06F 16/2453; G06F 16/93

(52) U.S. Cl. CPC G06F 16/2477; G06F 16/22; G06F 16/2453; G06F 16/93

(57) ABSTRACT

A method for storing and retrieving time-series data in a time-series database is disclosed. A digest associated with a document is obtained. The document is indexed in a search index including a plurality of index entries, wherein the plurality of index entries includes a first index entry having a key based on the digest and a value associated with a storage location of the document, and wherein each of the plurality of index entries has a common fixed key size and a common fixed value size. A search query is received. Whether any entry in the search index matches the search query is determined, including by searching at least a portion of the plurality of index entries of the search index addressable using an offset based on the common fixed key size and the common fixed value size.

### BACKGROUND OF THE INVENTION

A time-series is a series of data points in time order. The data points are measurements with timestamps. Time-series data includes data points recorded or measured over a series of discrete time intervals. Time-series data may be used in various fields, including finance, IoT (Internet of Things), monitoring systems, and scientific research. Examples of time-series data include weather records, economic indicators, patient health evolution metrics, server metrics, application performance monitoring metrics, network data, sensor data, events, clicks, and many other types of analytics data.

A time-series database (TSDB) is a specialized software system designed to efficiently store, manage, and retrieve time-series data. Time-series databases are valuable tools for organizations and applications that need to analyze and derive insights from time-ordered data, as they provide efficient and scalable storage and querying solutions tailored to this specific data format.

### BRIEF DESCRIPTION OF THE DRAWINGS

Various embodiments of the invention are disclosed in the following detailed description and the accompanying drawings.

FIG. 1 shows that machine-generated data may be sampled periodically and an aggregate of the values in each sampling period may be stored in a time-series database 104 of a time-series database server 102 until the data's expiration date.

FIG. 2 illustrates an exemplary process 200 for storing and retrieving time-series data in a time-series database.

FIG. 3 illustrates an exemplary process 300 for indexing the stored document in the search index.

FIG. 4 illustrates an exemplary process 400 for searching the indexed stored documents using the search index.

FIG. 5 is a functional diagram illustrating a programmed computer system for executing some of the processes in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A traditional time-series database may be used to store time-series data that is sampled at regular intervals. For example, a time-series database may be used to help developers working with IoT-based applications that monitor or act on large amounts of machine-generated data.

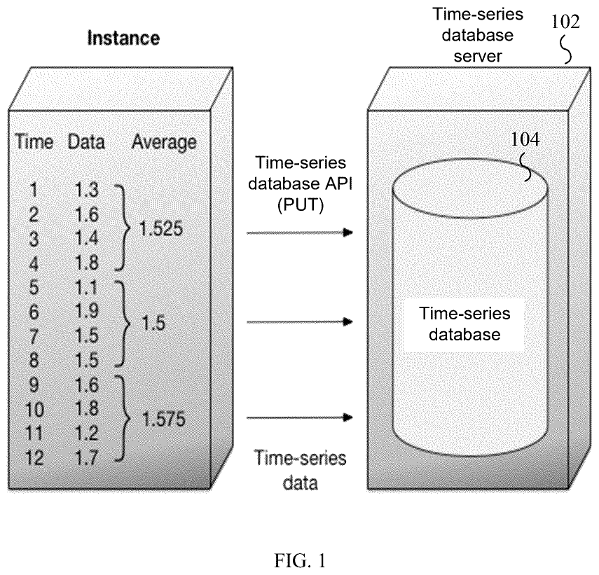

The time-series database may be used to handle large amounts of data by using a smaller summary of that data that is stored in the time-series database. For example, an instance might store data related to the central processing unit (CPU) usage of a computer. The data may be summarized by storing the average CPU usage for every five-minute interval. FIG. 1 shows that machine-generated data may be sampled periodically and an aggregate of the values in each sampling period may be stored in a time-series database 104 of a time-series database server 102 until the data's expiration date. The aggregate of values may be an average, a maximum, or a minimum, for example. For example, the machine-generated data that is stored on an instance may be sampled once every five minutes. This sampling rate is called the time-series definition. A time-series database application programming interface (API) may be used to send data from the instance to time-series database 104 at the rate that is prescribed by the time-series definition.

A time-series database may be used in different use cases. In one example, it may be used to create graphs about metrics, such as about CPU usage over time. In another example, it may be used to generate an email if the average CPU usage is more than a certain percentage in the last predetermined time period. In another example, it may be used to train a machine language model to detect anomalies and trigger a response when an anomaly is detected. In another example, it may be used to generate an email if a gap is detected in the submitted data. In another example, it may be used to generate an alert if the average of the collected data is outside a predetermined range. In yet another example, it may be used to generate an alert if memory usage is likely to exceed 90% in the next 10 minutes.

In a time-series database, an index is a data structure that facilitates efficient and fast retrieval of data points based on one or more conditions. The terms “data points” and “data elements” are herein used interchangeably. Indexing helps optimize queries to quickly locate relevant data. An index identifies or points to a location in the main storage where relevant data may be obtained. There are many types of indexing for time-series databases. As an example, in timestamp-based indexing, time-series databases use timestamp-based indexing to organize data points. Each data point is associated with a timestamp, which represents the time when the data was recorded. The index stores references to these data points and their corresponding timestamps. Efficient indexing is critical for achieving high-performance query capabilities in time-series databases, especially when dealing with large volumes of data.

Search tags in the context of a time-series database refer to metadata or labels that are associated with time-series data points. These tags are used to provide additional context and information about the data, making it easier to organize, query, and analyze time-series data effectively. Search tags are often used as metadata attributes that describe the data points that include measurements with timestamps. These metadata attributes can include information such as the source of the data, location, device ID, sensor type, and more. Tags help in categorizing and identifying data points based on their attributes. Search tags make it easy to filter and query time-series data based on specific criteria. For example, one may query all data points generated by a particular sensor, within a specific geographical area, during a specific time range.

The index stores the search tags that are associated with the time-series data points. The index contains pointer information to where the time-series data points are stored, as well as the search tags that may be used for keyword searches. When a keyword is received, the index is used to obtain the pointer information, and then the values for the time-series data may be resolved based on the lookup in the index.

In the present application, a system and method for storing and retrieving time-series data in a time-series database are disclosed. A document is stored. A digest for the document is generated. The stored document is indexed in a search index. An index entry having a key based on the digest and a value associated with a storage location of the stored document is stored in the search index, wherein the search index includes a plurality of index entries each having a same fixed key size and a same fixed value size. A search query is received. Whether any entry in the index matches the search query is determined, including by searching at least a portion of the plurality of entries of the search index addressable using an offset based on the same fixed key size and the same fixed value size.

In the present application, an improved time-series database that includes an index to support indexing/searching tag data, as well as to optimize timestamp/measurement searching for time-series data is disclosed. One challenge is that for each update (which may happen very frequently) to the main storage with a new data element with a timestamp, a corresponding primary key index lookup and a corresponding update to the index are required. A primary key index lookup is a database operation used to quickly retrieve a specific record from a database table by specifying its primary key value. The primary key is a unique identifier for each record in the table, and it ensures that no two records have the same key value. Since the updates may happen once per minute for every time-series, many primary key index lookup operations are required. Additionally, the index is itself represented as a collection of sub-indexes, requiring each primary key lookup to be evaluated for all sub-indexes. In an information technology (IT) management scenario of a large company with tens of thousands of end users, each end user laptop's CPU percentage usage, temperature, “on/off” state, etc. would be a separate time-series, each with a high data volume. For example, the time-series data corresponding to the CPU temperature with a timestamp granularity of one minute will require many primary key index lookups. Primary key index lookups and updating the index are much more expensive operations than writing the time-series data itself, as the data may be stored in a write efficient manner. For example, the time-series data may be stored in a round-robin database (RRD), in which fixed-size records are pre-allocated. A round-robin database is a special type of storage designed to store data in a file or memory-mapped ring buffers. Since the data is stored in a circular buffer-based database, the system storage footprint remains constant over time. Therefore, improved techniques of the index insert/update logic that enables efficient primary key lookups to determine if an existing record needs to be updated or a new record needs to be inserted into the index for the time-series database would be desirable.

Some other techniques (e.g., the Lucene index) support generic functionalities, including keys with variable key length, each given key matching and mapping to one or multiple records/documents, and the like. These generic functionalities provide flexibility but significantly increase the overheads, and thereby decrease the efficiency and indexing throughput of the system. By exploiting the fact that for primary key lookups, each key is mapped to a single document, and furthermore by using fixed-length keys (e.g., fixed-length keys that are based on message digests), the improved techniques reduce the overheads and significantly improve the efficiency and throughput of the system. The terms “fixed-length” and “fixed-size” are herein used interchangeably. The improved time-series database techniques have many advantages and benefits. The disclosed primary key index includes keys of fixed length (uniformly distributed), and each key represents a one-to-one mapping to a matching record. This new index is block-based, allowing constant-time access to a block for a given key. Each block contains a Bloom filter and a list of key/record ID pairs in sorted order by key. The operations are constant-time operations and allow filtering out non-matching documents quickly. The constant-time checks allow for quickly determining search keys that do not match for a given sub-index and reduce the number of key comparisons. The fixed-size key/record ID allows for performing binary search over the key data without requiring linear-time key scan or additional index structures.

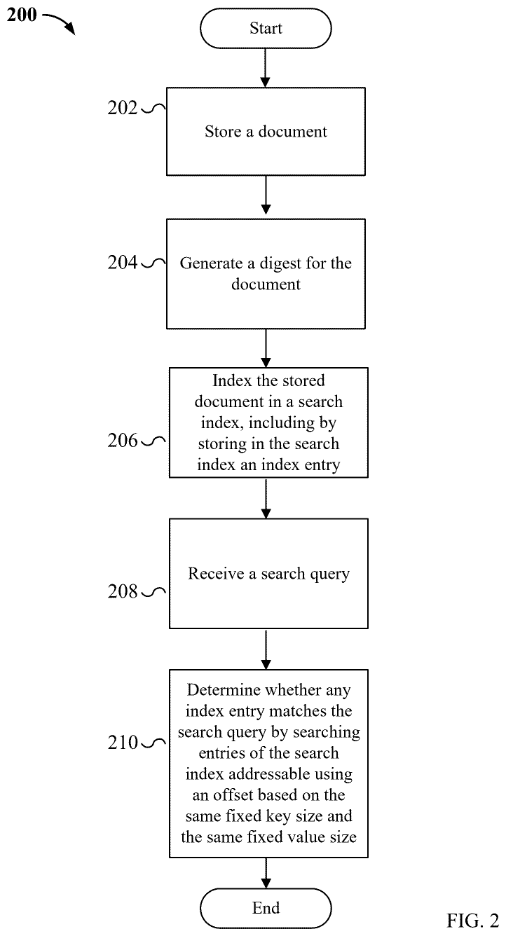

FIG. 2 illustrates an exemplary process 200 for storing and retrieving time-series data in a time-series database. In some embodiments, process 200 may be performed by time-series database server 102 and time-series database 104.

At step 202, a document is stored. In particular, the document being stored is a data stream collected at a periodic collection time interval. The terms “document” and “data stream” are herein used interchangeably. The data stream is a time-series data stream. Examples of time-series data include weather records, economic indicators, patient health evolution metrics, server metrics, application performance monitoring metrics, network data, sensor data, events, clicks, and many other types of analytics data. For illustrative purposes only, the example time-series data stream is the data sent from one of a plurality of computers within an enterprise network that may be used to report certain computer information related to the computer, such as the computer “on/off” time, temperature, and the like.

The data stream is collected at a periodic collection time interval, also referred to as a time-series timestamp period. For example, the computer information may be sampled once every minute. The periodic collection time interval of the sampled data points (i.e., sampled data elements) in this example is one minute. Each data element is a single piece of data. Each data element may include one or more measurements or values. For example, the one or more measurements may include a single observation of the computer's “on/off” state, temperature, location, and the like.

The received time-series data stream may be stored in a main storage of the time-series database. For example, the time-series data may be stored in a round-robin database (RRD), in which fixed-size records are pre-allocated. A round-robin database is a special type of storage designed to store data in a file or memory-mapped ring buffers. Since the data is stored in a circular buffer-based database, the system storage footprint remains constant over time. However, other types of databases may be used as well.

At step 204, a digest for the document is generated and obtained. The document/data stream may be uniquely identified by a unique identifier. Continuing with the example that the time-series data stream is the data sent from one of a plurality of computers within an enterprise network that is used to report the computer's temperature over time, then the time-series data stream may have one or more tags that are associated with it, which may be used to uniquely identify the time-series data stream. For example, the one or more associated tags may indicate the computer, the user of the computer, the computer's location, and the like. The tags may be used to generate a unique identifier as a raw primary key.

A message digest for the document/data stream is then generated based on the unique raw primary key for the time-series data stream. As will be described in greater details below, an internal primary key may be generated based on the message digest for use as the primary key of an index.

A message digest, often referred to simply as a “hash,” is a fixed-size string of characters or numbers generated from an input data of arbitrary size. The purpose of a message digest is to represent the input data in a condensed and unique form. This condensed form is typically a fixed length, regardless of the size of the input data. For example, the unique identifier for the time-series data stream is the input data for generating the fixed-length message digest that is evenly distributed and cryptographically secure. Message digests are designed to be one-way functions such that it is computationally infeasible to reverse the process and derive the original input data from the digest. Additionally, a small change in the input data should result in a significantly different message digest, providing a unique representation for each unique input.

Different algorithms may be used to generate the fixed-length message digest, including MD5 (Message Digest Algorithm 5), SHA-1 (Secure Hash Algorithm 1), and SHA-256 (Secure Hash Algorithm 256). The older algorithms, such as MD5 and SHA-1 are now considered weaker for security-critical applications due to vulnerabilities that allow for collision attacks. SHA-256 and other SHA-2 family members are more secure and widely used today.

At step 206, the stored document/data stream is indexed in a search index, including by storing in the search index an index entry having a key based on the digest and a value associated with a storage location of the stored document/data stream, wherein the search index includes a plurality of index entries each having a common fixed key size and a common fixed value size. The search index may be used to index a total number of documents, which is referred to as the document count. Document IDs are integers ranging from 0 to the document count-1. The search index includes a list of index entries with their primary key values sorted in ascending order.

In a time-series database, an index is a data structure that facilitates efficient and fast retrieval of time-ordered data points based on one or more conditions. Indexing helps optimize queries to quickly locate relevant data. Indexing the stored document enables the index of the stored document to identify or point to a storage location of the stored document where relevant data may be obtained. For example, an index may be used to search for a particular value, such as the computer's “on/off” state, temperature, location, and the like. Multiple indexes may be defined for the stored document. These enable the administrator of an enterprise to determine different problems, including which specific computers were on, which specific computers were overheated, which specific computers had crashed, which ones were running out of memory, and the like.

In some embodiments, primary keys for the search index are Universally Unique Identifiers (UUIDs). For example, a 128-bit UUID may be computed according to a hash function based on the primary key fields. A hash function may be used to produce globally unique and uniformly distributed keys across all inputs. A hash function may be used to produce a minimally sized fixed-length key with a low probability of collisions.

In some embodiments, a primary key may be formed based on at least a portion of the message digest, which is a fixed-length uniformly distributed hash generated at step 204 of process 200. In some embodiments, the primary key comprises the first n-bits of the message digest. For example, with an SHA-512 hash, the first 128-bits of the SHA-512 hash may be used as the primary key. With a 128-bits MD5 hash, the entire 128 bits of the MD5 hash may be used as the primary key. In general, a smaller hash may increase the likelihood of collisions, whereas a larger hash may increase the index size and increase the constant factors for search performance.

By exploiting the fact that for primary key lookups, each key represents a one-to-one mapping to a matching document, an index entry of the search index needs only to store a value associated with a storage location of the stored document. In particular, the stored value is a pointer for pointing to a storage location of the stored document. The index entry further stores the matching primary key of the search index, which is a fixed-length primary key that is based on the message digest generated at step 204 of process 200. Accordingly, each index entry in the search index is a fixed-length index entry because the stored pointer and the stored key in the index entry are both fixed in size. In some embodiments, each row of the search index is written as a fixed-length key followed by a fixed-length pointer. Therefore, the search index includes a plurality of index entries, each having a common fixed key size and a common fixed value size.

One of the advantages of having fixed-length index entries in the search index is that it significantly simplifies the way to locate a given index entry within the search index, as will be described in greater details below. In some embodiments, a particular index entry may be located by direct addressing into a block of storage or data structure for storing the search index entries. In some embodiments, a particular fixed-length index entry may be located by performing a binary search in the search index.

At step 208, a search query is received, which is a request to retrieve data from a database. The search query may include information that specifies the criteria for selecting the desired data. For example, search queries are used to find records or documents that match certain keywords or meet specific criteria. Based on the search query, a primary key is determined for use in a primary key lookup. For example, at least a portion of the criteria indicated in the search query is used to form a target unique primary key for the primary key lookup.

At step 210, whether any index entry in the search index matches the search query is determined, including by searching at least a portion of the plurality of index entries of the search index addressable using an offset based on the same fixed key size and the same fixed value size. The target unique primary key obtained at step 208 is used for a primary key lookup into the search index.

In some embodiments, the primary key lookup into the search index includes locating a particular index entry that matches the search query by direct addressing into a block of storage or data structure for storing the search index entries. Suppose that the index entries are sorted in the search index based on the primary keys, and the target unique primary key obtained at step 208 corresponds to a particular index entry that is the n^{th} index entry in the search index, then the index entry is addressable based on the beginning address associated with the block or data structure and a fixed offset from the beginning address. The fixed offset may be determined based on the relative position (i.e., the n^{th} position) where the particular index entry is stored in the search index and a predetermined fixed-size of each of the index entries in the search index. The size of each of the index entries in the search index is a predetermined fixed-size based on the fixed key size and the fixed value size.

In some embodiments, the primary key lookup into the search index includes locating a particular fixed-length index entry that matches the search query by performing a binary search in the search index. Binary search is a search algorithm used for efficiently searching for a specific element in a sorted collection, such as a sorted list. It is based on the divide-and-conquer strategy and is known for its speed and efficiency. In some embodiments, the index entries of the search index are sorted by their corresponding fixed-length keys. The binary search starts with an initial search space. Binary search may be used to compare the target key (i.e., the target unique primary key) to the key corresponding to the middle index entry of the current search space of the data structure. As any index entry is addressable based on the beginning address of the search index and a fixed offset from the beginning address, the middle index entry and its key of any given current search space within the data structure can be located and determined. If the target key and the key corresponding to the middle index entry are not equal, then the half in which the target key cannot lie within is eliminated. The search then continues on the remaining half as the new search space, again taking the key corresponding to the middle index entry of this new search space to compare to the target key. The search is repeated until the target key is found. If the search ends with the remaining half being empty, then it may be determined that the target key is not in the data structure.

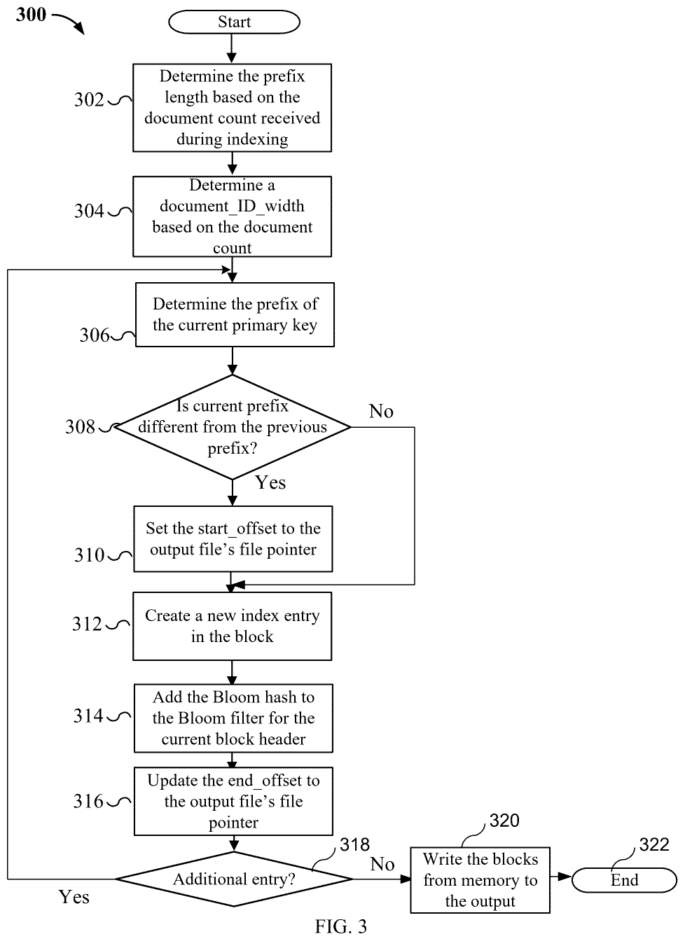

FIG. 3 illustrates an exemplary process 300 for indexing the stored document in the search index. In some embodiments, process 300 may be performed by time-series database server 102 and time-series database 104 at step 206 of process 200.

In some embodiments, the search index data structure for storing the index entries is divided into a plurality of blocks, where all keys in the same block share the same prefix. A prefix of the key is the beginning number of bits of the key. For example, the prefix of the key may be the first 8 bits of the key. Suppose that the primary keys are 128-bits in length, the prefix length is the number of bits of the prefix of the primary keys that is shared by the same block. In some embodiments, the prefix length is a predetermined length between 8 bits to 12 bits in length. In some embodiments, the prefix length may be determined based on the document count. For example, if the prefix length is configured as 8 bits in length, then the first 8 bits of the primary keys of the index entries are used to form the prefix. Every primary key in a particular block will share the same 8-bits prefix. One advantage is that the shared prefix for any given block does not need to be repeatedly stored in each of the index entries within the block, thereby reducing the storage space needed for the block. In addition, during a primary key lookup, the first 8-bits of the query key may be used to directly address the block for that prefix, thereby increasing the efficiency of the lookup.

In some embodiments, each block may include a block header for storing header information of the particular block. The block header may include an integer start_offset field, which indicates the starting offset for the block data on a storage disk. The block header may further include an integer end_offset field, which indicates the ending offset for the block data on the storage disk. In addition, the block header may further include a Bloom filter (e.g., a 64-bit Bloom filter) for the keys in the block. The Bloom hash does not include the bits corresponding to the shared prefix. In some embodiments, instead of using a Bloom filter, a cuckoo filter may be used.

A Bloom filter or a cuckoo filter is a space-efficient probabilistic filter that is used to test whether an element (e.g., an index entry) is a member of a set (e.g., a block) in constant time. False positive matches are possible, but false negatives are not. A query returns either “possibly in the set” or “definitely not in the set.” In other words, if a Bloom filter lookup returns a false value, it is certain that the value is not in the set; otherwise, the value may be in the set and additional checks are necessary to confirm that it is actually in the set. Therefore, a Bloom filter has the advantage of enabling a quick early exit when a value is not within the set.

Bloom filters are typically used for applications where the amount of source data would require an impractically large amount of memory if “conventional” error-free hashing techniques were applied. With sufficient core memory, an error-free hash could be used to eliminate all unnecessary disk accesses; on the other hand, with limited core memory, a Bloom filter uses a smaller hash area but still eliminates most unnecessary accesses. For example, a hash area only 15% of the size needed by an ideal error-free hash still eliminates 85% of the disk accesses. More generally, fewer than 10 bits per element are required for a 1% false positive probability, independent of the size or number of elements in the set.

In some embodiments, the search index may further include a block index. The block index stores the prefix length, the document_ID_width, and an array of all the block headers. The prefix length specifies the number of bits of the prefix, which is shared by the same block. The document_ID_width is the width of the document ID data (will be 2, 3 or 4), which allows compressing the document IDs for the indexes when the document count is not large. The array of all the block headers is BlockHeader [(1<<prefix length)]. The array has a size that is based on the prefix length. For instance, if the prefix length is eight bits, then there are a total of 256 block headers. The index into the array is the first prefix length bits of the key (i.e., the prefix).

At steps 302 and 304, the block index is initialized. At step 302, a prefix length is determined based on the document count that is received during indexing. In some embodiments, the prefix length is a predetermined length between 8 bits to 12 bits in length. For example, a larger document count requires a larger number of blocks and a larger prefix length.

At step 304, a document_ID_width is determined based on the document count. For example, the document_ID_width may be set to 2 bytes if the document count is less than 65536 (i.e., 2¹⁶); the document_ID_width may be set to 3 bytes if the document count is less than 16777216 (i.e., 2²⁴); otherwise, the document_ID_width may be set to 4 bytes, such that there is no compression.

Steps 306 to 318 form a loop to create the index entries corresponding to each primary key, wherein the index entries sharing the same common prefix of their primary keys are stored in the same block.

At step 306, the prefix of the current primary key is determined. For example, if the prefix length is configured as 8 bits in length, then the first 8 bits of the current primary key are used to form the prefix. Every primary key in a particular block will share the same 8-bits prefix.

At step 308, it is determined whether the current prefix is different from the previous prefix. Because the list of primary keys received as inputs to this process is sorted based on the primary keys, the current prefix only needs to be compared to the previous prefix.

If the current prefix is different from the previous prefix, then process 300 proceeds to step 310, such that a new block is then created and initialized. Otherwise, if the current prefix is the same as the previous prefix, then the index entry for the current primary key may be stored in the same block. Accordingly, process 300 proceeds to step 312, such that no new block is created. The advantage of receiving the list of primary keys as a sorted list is that there is no need to go to any previous blocks, and when the prefix is changed, a new block is created and the new block will be placed after the current block.

At step 310, a new block and a new block header for the block is created and initialized. The block header is used to store header information of the particular block. The block header includes an integer start_offset field, which indicates the starting offset for the block data on a storage disk. The start_offset is set to the output file's file pointer.

At step 312, a new index entry is created in the current block. The primary key corresponding to the index entry is written to the index entry. A pointer for pointing to a storage location of the stored document corresponding to the index entry is written to the index entry as well. The pointer is the value of the index entry and is the document ID, which is a pointer to the output file. In some embodiments, the document ID is compressed based on the document_ID_width. For example, document_ID_width may be set to 2 bytes if the document count is less than 65536 (i.e., 2¹⁶); document_ID_width may be set to 3 bytes if the document count is less than 16777216 (i.e., 2²⁴); otherwise, document_ID_width may be set to 4 bytes, such that there will be no compression. The document ID is compressed to remove the extra zero bits from the document ID.

At step 314, the Bloom filter is updated based on the primary key. The Bloom hash is added to the Bloom filter for the current block header. Once the index entry is written to the output file, the Bloom hash is added to the Bloom filter for the current block header. The primary key is resolved to be one or more bits in the 64-bit Bloom filter, and those bits are marked as true in the Bloom filter for the current block.

At step 316, the end_offset field is updated. The block header includes an integer end_offset field, which indicates the ending offset for the block data on the storage disk. The end_offset is set to the file pointer after the writing of the index entry. The end_offset is updated to the output file's file pointer.

At step 318, it is determined whether there is another additional entry for another primary key to process. If there is another additional entry, then process 300 proceeds back to step 306 to process the next primary key and its index entry; otherwise, process 300 proceeds to step 320.

At step 320, after all the primary keys are processed, the blocks and the block index data are written from memory to the output file. After step 320, process 300 terminates at step 322.

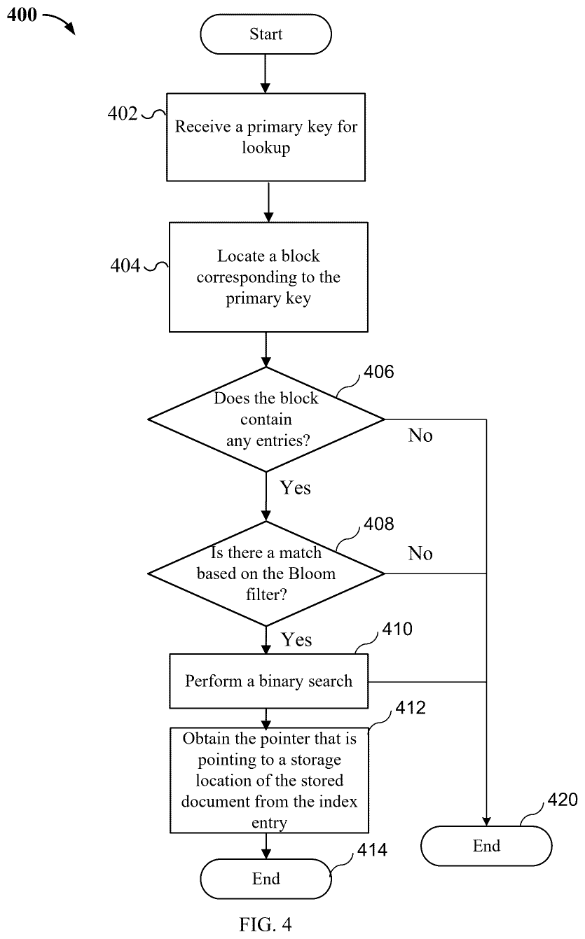

FIG. 4 illustrates an exemplary process 400 for searching the indexed stored documents using the search index. In some embodiments, process 400 may be performed by time-series database server 102 and time-series database 104 at step 210 of process 200. Process 400 receives a primary key and resolves it to a matching document ID of the corresponding document.

At 402, a primary key for the primary key lookup is received. In some embodiments, the primary key is an array with 16 elements in bytes.

At 404, a block corresponding to the primary key is located. The located block is the block containing an index entry with the primary key. The block ID is the prefix extracted from the primary key. The block ID may be used to index into an array of pointers to the blocks to obtain a pointer to the corresponding block. In other words, the obtained pointer is the pointer to the block that may contain the index entry with the primary key.

At 406, it is determined whether the block contains any index entries. The block header includes an integer start_offset field, which indicates the starting offset for the block data on a storage disk. The block header also includes an integer end_offset field, which indicates the ending offset for the block data on the storage disk. Therefore, if the start_offset field is equal to the end_offset field, then the block is empty. If the block is empty, then there are no matching index entries in the search index and process 400 exits and terminates at step 420, returning a no match result.

At 408, it is determined whether there is a match based on the Bloom filter. If a Bloom filter lookup returns a false value, then it is certain that the primary key does not have a match and the block does not contain an index entry for that primary key. Accordingly, process 400 may exit and terminate at step 420, returning a no match result. If the Bloom filter lookup returns a true value, then the primary key may be in this block and additional checks are necessary to confirm that it is actually in the block at step 410.

At 410, a binary search is performed to locate an index entry with a matching primary key. The index entries of the block are sorted by their corresponding fixed-length keys. The initial search space is the entire block. The block header includes the integer start_offset field, which indicates the starting offset for the block data on a storage disk. The block header further includes the integer end_offset field, which indicates the ending offset for the block data on the storage disk. Since each index entry has a fixed length, a binary search may be used to search for a matching index entry efficiently. If the binary search returns a false value, then no match is found. Accordingly, process 400 exits and terminates at step 420, returning a no match result. If the binary search locates a matching index entry, then process 400 proceeds to step 412.

At step 412, the pointer that is pointing to a storage location of the stored document is obtained from the index entry. Process 400 then proceeds to step 414 with the pointer returned as a result.

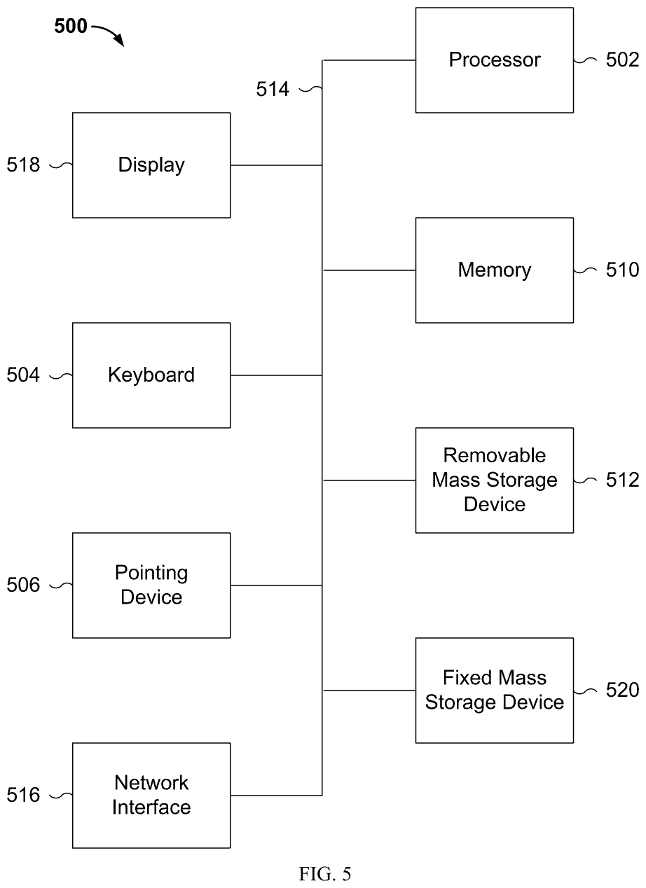

FIG. 5 is a functional diagram illustrating a programmed computer system for executing some of the processes in accordance with some embodiments. As will be apparent, other computer system architectures and configurations can be used as well. Computer system 500, which includes various subsystems as described below, includes at least one microprocessor subsystem (also referred to as a processor or a central processing unit (CPU)) 502. For example, processor 502 can be implemented by a single-chip processor or by multiple processors. In some embodiments, processor 502 is a general purpose digital processor that controls the operation of the computer system 500. Using instructions retrieved from memory 510, the processor 502 controls the reception and manipulation of input data, and the output and display of data on output devices (e.g., display 518). In some embodiments, processor 502 includes and/or is used to execute/perform processes 200, 300, and 400 described above with respect to FIGS. 2-4.

Processor 502 is coupled bi-directionally with memory 510, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 502. Also as is well known in the art, primary storage typically includes basic operating instructions, program code, data and objects used by the processor 502 to perform its functions (e.g., programmed instructions). For example, memory 510 can include any suitable computer-readable storage media, described below, depending on whether, for example, data access needs to be bi-directional or uni-directional. For example, processor 502 can also directly and very rapidly retrieve and store frequently needed data in a cache memory (not shown).

A removable mass storage device 512 provides additional data storage capacity for the computer system 500 and is coupled either bi-directionally (read/write) or uni-directionally (read only) to processor 502. For example, storage 512 can also include computer-readable media such as magnetic tape, flash memory, PC-CARDS, portable mass storage devices, holographic storage devices, and other storage devices. A fixed mass storage 520 can also, for example, provide additional data storage capacity. The most common example of mass storage 520 is a hard disk drive. Mass storages 512, 520 generally store additional programming instructions, data, and the like that typically are not in active use by the processor 502. It will be appreciated that the information retained within mass storages 512 and 520 can be incorporated, if needed, in standard fashion as part of memory 510 (e.g., RAM) as virtual memory.

In addition to providing processor 502 access to storage subsystems, bus 514 can also be used to provide access to other subsystems and devices. As shown, these can include a display monitor 518, a network interface 516, a keyboard 504, and a pointing device 506, as well as an auxiliary input/output device interface, a sound card, speakers, and other subsystems as needed. For example, the pointing device 506 can be a mouse, stylus, track ball, or tablet, and is useful for interacting with a graphical user interface.

The network interface 516 allows processor 502 to be coupled to another computer, computer network, or telecommunications network using a network connection as shown. For example, through the network interface 516, the processor 502 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 502 can be used to connect the computer system 500 to an external network and transfer data according to standard protocols. For example, various process embodiments disclosed herein can be executed on processor 502 or can be performed across a network such as the Internet, intranet networks, or local area networks, in conjunction with a remote processor that shares a portion of the processing. Additional mass storage devices (not shown) can also be connected to processor 502 through network interface 516.

An auxiliary I/O device interface (not shown) can be used in conjunction with computer system 500. The auxiliary I/O device interface can include general and customized interfaces that allow the processor 502 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 5 is but an example of a computer system suitable for use with the various embodiments disclosed herein. Other computer systems suitable for such use can include additional or fewer subsystems. In addition, bus 514 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
obtaining a digest associated with a document;
indexing the document in a search index including a plurality of index entries, wherein the plurality of index entries includes a first index entry having a key based on the digest and a value associated with a storage location of the document, and wherein each of the plurality of index entries has a common fixed key size and a common fixed value size;
receiving a search query; and
determining whether any index entry in the search index matches the search query, including by searching at least a portion of the plurality of index entries of the search index addressable using an offset based on the common fixed key size and the common fixed value size.

2. The method of claim 1, further comprising:
generating the key based on at least a portion of the digest generated for the document, wherein the digest generated for the document comprises a fixed-length message digest, and wherein the key has a one-to-one mapping to the document.

3. The method of claim 1, wherein the key is associated by one-to-one mapping to the value associated with the storage location of the document.

4. The method of claim 1, wherein the determining of whether any index entry in the search index matches the search query comprises:
determining a primary key based on the search query; and
determining whether any index entry in the search index matches the primary key based on a primary key lookup in the search index.

5. The method of claim 1, further comprising:
determining a prefix of the key, wherein the prefix of the key comprises a beginning number of bits of the key, wherein the number of bits is a prefix length; and
storing the first index entry in a particular block of a plurality of blocks of the search index based on the prefix of the key, wherein a group of index entries stored in the particular block share an identical prefix.

6. The method of claim 5, further comprising:
determining the prefix length based on a document count in the search index.

7. The method of claim 5, further comprising:
storing in a block header of the particular block a start offset field, wherein the start offset field indicates a starting offset of the particular block on a storage disk;
storing in the block header of the particular block an end offset field, wherein the end offset field indicates an ending offset of the particular block on the storage disk; and
storing a probabilistic filter that is used to test whether an indicated index entry is not a member of the particular block.

8. The method of claim 7, wherein the probabilistic filter comprises a Bloom filter.

9. The method of claim 7, further comprising:
determining a primary key based on the search query; and
locating the particular block based on a prefix of the primary key.

10. The method of claim 9, further comprising:
determining whether the particular block contains at least one index entry based on the start offset field and the end offset field of the particular block; and
based at least in part in determining that the particular block does not contain at least one index entry, providing an indication that there is not any index entry matching the search query.

11. The method of claim 10, further comprising:
using the probabilistic filter to determine whether there is not any index entry that matches the search query;
in response to determining that there is not any index entry that matches the search query using the probabilistic filter, indicating that there is not any index entry matching the search query; and
in response to determining that the probabilistic filter cannot determine whether there is a match, performing a binary search on the particular block.

12. A system, comprising:
a processor configured to:
obtain a digest associated with a document;
index the document in a search index including a plurality of index entries, wherein the plurality of index entries includes a first index entry having a key based on the digest and a value associated with a storage location of the document, and wherein each of the plurality of index entries has a common fixed key size and a common fixed value size;
receive a search query; and
determine whether any index entry in the search index matches the search query, including by searching at least a portion of the plurality of index entries of the search index addressable using an offset based on the common fixed key size and the common fixed value size; and
a memory coupled to the processor and configured to provide the processor with instructions.

13. The system of claim 12, wherein the processor is further configured to:
generate the key based on at least a portion of the digest generated for the document, wherein the digest generated for the document comprises a fixed-length message digest, and wherein the key has a one-to-one mapping to the document.

14. The system of claim 12, wherein the determining of whether any index entry in the search index matches the search query comprises to:
determine a primary key based on the search query; and
determine whether any index entry in the search index matches the primary key based on a primary key lookup in the search index.

15. The system of claim 12, wherein the processor is further configured to:
determine a prefix of the key, wherein the prefix of the key comprises a beginning number of bits of the key, wherein the number of bits is a prefix length; and
store the first index entry in a particular block of a plurality of blocks of the search index based on the prefix of the key, wherein a group of index entries stored in the particular block share an identical prefix.

16. The system of claim 15, wherein the processor is further configured to:
store in a block header of the particular block a start offset field, wherein the start offset field indicates a starting offset of the particular block on a storage disk;
store in the block header of the particular block an end offset field, wherein the end offset field indicates an ending offset of the particular block on the storage disk; and
store a probabilistic filter that is used to test whether an indicated index entry is not a member of the particular block.

17. The system of claim 16, wherein the processor is further configured to:
determine a primary key based on the search query; and
locate the particular block based on a prefix of the primary key.

18. The system of claim 17, wherein the processor is further configured to:
determine whether the particular block contains at least one index entry based on the start offset field and the end offset field of the particular block; and
based at least in part in determining that the particular block does not contain at least one index entry, provide an indication that there is not any index entry matching the search query.

19. The system of claim 18, wherein the processor is further configured to:
use the probabilistic filter to determine whether there is not any index entry that matches the search query;
in response to determining that there is not any index entry that matches the search query using the probabilistic filter, indicate that there is not any index entry matching the search query; and
in response to determining that the probabilistic filter cannot determine whether there is a match, perform a binary search on the particular block.

20. A computer program product embodied in a non-transitory computer readable medium and comprising computer instructions for:
obtaining a digest associated with a document;
indexing the document in a search index including a plurality of index entries, wherein the plurality of index entries includes a first index entry having a key based on the digest and a value associated with a storage location of the document, and wherein each of the plurality of index entries has a common fixed key size and a common fixed value size;
receiving a search query; and
determining whether any index entry in the search index matches the search query, including by searching at least a portion of the plurality of index entries of the search index addressable using an offset based on the common fixed key size and the common fixed value size.
